(19) United States
(12) Patent Application Publication
(10) Pub. No.: US 2017/0160824 A1
(43) Pub. Date: Jun. 8, 2017

(54) DATA INPUT VIA MULTIPLE WRITING DEVICES

(71) Applicant: Lenovo (Beijing) Limited, Beijing (CN)

(72) Inventor: Binqiang Ma, Beijing (CN)

(21) Appl. No.: 15/080,790

(22) Filed: Mar. 25, 2016

(30) Foreign Application Priority Data
Dec. 7, 2015 (CN) 201510890329.4

(51) Int. Cl. G06F 3/0354; G06T 1/00

(52) U.S. Cl. CPC G06F 3/03545; G06T 1/0007

(57) ABSTRACT

Disclosed is an electronic device, comprising: an input device; a plurality of writing devices that operatively input data via the input device and send signals, wherein each writing device sends signals from a position of the input device where the writing device is located, the signals comprising a unique characteristic; and a receiver that operatively receives the signals of different characteristics from the plurality of writing devices, so as to determine the respective positions of the input device where the writing devices are located.

### FIELD

The subject matter disclosed herein relates to the field of electronics, and more particularly to an information processing method and an electronic device.

### BACKGROUND

With the development of man-machine interaction technologies, an increasing number of electronic devices, such as tablet computers and smartphones, are equipped with stylus pens; the tracks of the pen are recorded using various methods and then recognized as text or patterns, which provides great convenience to people who do not like to use keyboards or Chinese input methods, and ensures the multifunctional nature of the electronic devices.

In the prior art, the function of handwriting input to the projected image or the display area of the display can be realized by using an infrared camera in combination with a pen that can emit infrared light.

In the process of implementing the technical solutions in the embodiments of the present application, the inventor of the present application has found that the prior art at least has the following technical problem:

In the prior art, an electronic device can support the handwriting operations of only one stylus pen. Therefore, the prior art has the technical problem that an electronic device cannot support handwriting operations of multiple stylus pens at the same time.

### SUMMARY

Embodiments disclosed herein provide an electronic device that comprises an input device and a plurality of writing devices that operatively input data via the input device. In general terms, the electronic device is capable of determining respective positions of the input device where the plurality of writing devices are located.

Disclosed is an electronic device, comprising an input device; a plurality of writing devices that operatively input data via the input device and send signals, wherein each writing device sends signals from a position of the input device where the writing device is located, the signals comprising a unique characteristic; and a receiver that operatively receives the signals of different characteristics from the plurality of writing devices, so as to determine the respective positions of the input device where the writing devices are located.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, embodiments will be described and explained with additional specificity and detail through the use of the accompanying drawings, in which:

FIG. 1 is a flow chart of an information processing method that is provided by a first embodiment of the present application;

FIG. 2 is a flow chart of step S103 in the information processing method that is provided by the first embodiment of the present application;

FIG. 3 is a flow chart of a first implementation manner of step A in the information processing method that is provided by the first embodiment of the present application;

FIG. 4 is a flow chart of a second implementation manner of step A in the information processing method that is provided by the first embodiment of the present application;

FIG. 5 is a flow chart of step S301 or step S401 in the information processing method that is provided by the first embodiment of the present application;

FIG. 6 is a structural block diagram of an electronic device that is provided by a second embodiment of the present application; and

FIG. 7 is a structural block diagram of an electronic device that is provided by a third embodiment of the present application.

### DETAILED DESCRIPTION

The embodiments of the present embodiments provide an information processing method and an electronic device, so as to solve the technical problem in the prior art that an electronic device cannot support handwriting operations of multiple stylus pens at the same time, and achieve the technical effect that an electronic device can support handwriting operations of multiple stylus pens at the same time.

In the present application, a receiver of an electronic device is controlled to perform image acquisition on an ith writing device in M writing devices at an ith acquisition position to obtain a first acquired image set, wherein i is an integer greater than or equal to 1 and smaller than or equal to M, the ith acquisition position is smaller than an image acquisition position of the receiver, and M is an integer greater than or equal to 2; the receiver is controlled to perform image acquisition on a jth writing device in the M writing devices at a jth acquisition position to obtain a second acquired image set, wherein j is an integer greater than or equal to 1 and smaller than or equal to M, and j is an integer different from i; a first location of the ith writing device is determined according to the ith acquisition position and the first acquired image set; and a second location of the jth writing device is determined according to the jth acquisition position and the second acquired image set. That is to say, the receiver of the electronic device is controlled to perform image acquisition on each writing device among multiple writing devices at different sampling frequencies, and further the location of each writing device can be determined, thereby achieving the technical effect that the electronic device can support handwriting operations of multiple stylus pens at the same time.

In this specification, the term “and/or” merely describes an association relationship between associated objects, and indicates that three relationships may exist. For example, A and/or B may indicate that: A exists alone, both A and B exist, or B exists alone. In addition, unless otherwise particularly specified, the symbol “/” herein generally indicates an “or” relationship between associated objects before and after the symbol.

To make the above technical solution more comprehensible, the technical solutions of the present embodiments are described in detail below through specific embodiments with reference to the accompanying drawings. It should be appreciated that the embodiments of the present application and specific features in the embodiments are intended to describe in detail the technical solutions of the present embodiments rather than to limit the technical solutions of the present embodiments. The embodiments of the present application and the technical features in the embodiments can be combined together as long as no conflict occurs.

### First Embodiment

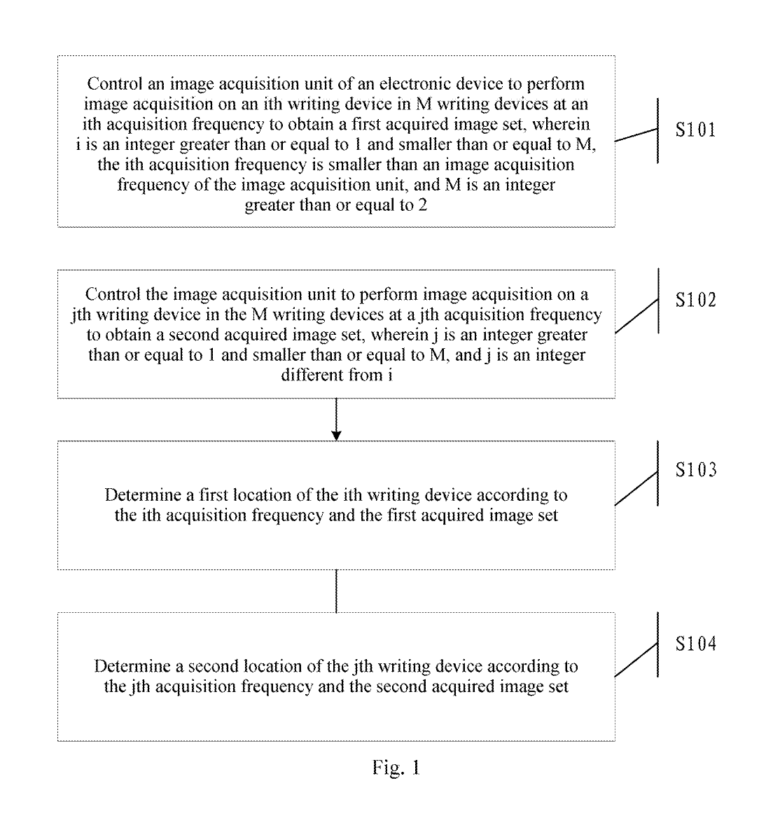

Referring to FIG. 1, the first embodiment of the present application provides an information processing method, including:

S101: controlling a receiver of an electronic device to perform image acquisition on an ith writing device in M writing devices at an ith acquisition position to obtain a first acquired image set, wherein i is an integer greater than or equal to 1 and smaller than or equal to M, the ith acquisition position is smaller than an image acquisition position of the receiver, and M is an integer greater than or equal to 2;

S102: controlling the receiver to perform image acquisition on a jth writing device in the M writing devices at a jth acquisition position to obtain a second acquired image set, wherein j is an integer greater than or equal to 1 and smaller than or equal to M, and j is an integer different from i;

S103: determining a first location of the ith writing device according to the ith acquisition position and the first acquired image set; and

S104: determining a second location of the jth writing device according to the jth acquisition position and the second acquired image set.

In a specific implementation process, step S101 to step S104 are specifically implemented as the following process:

Firstly, a receiver of an electronic device is controlled to perform image acquisition on an ith writing device in M writing devices at an ith acquisition position to obtain a first acquired image set. And, the receiver is controlled to perform image acquisition on a jth writing device in the M writing devices at a jth acquisition position to obtain a second acquired image set. The first acquired image set includes at least one image, and the second acquired image set includes at least one image. For a specific example, there are currently two infrared pens A and B, and a camera of the electronic device samples the infrared pen A at odd-numbered acquisition positions, and samples the infrared pen B at even-numbered acquisition positions. For example, when the sampling rate of the camera is 60 frames or acquisition positions per second, the camera performs image acquisition on the infrared pen A on the basis of acquisition positions “1, 3, . . . 59” in the acquisition frequency, and the camera performs image acquisition on the infrared pen B on the basis of “2, 4, . . . 60” in the acquisition frequency. For another example, when there are currently three infrared pens C, D and E, and the sampling rate of the camera is still 60 frames per second, the camera performs image acquisition on the infrared pen C on the basis of “1, 4, 7, . . . 58” in the acquisition frequency, the camera performs image acquisition on the infrared pen D on the basis of “2, 5, 8, . . . 59” in the acquisition frequency, and the camera performs image acquisition on the infrared pen E on the basis of “3, 6, 9, . . . 60” in the acquisition frequency.

After acquiring an image set of each writing device, the electronic device performs image recognition on each image in the image set of each writing device, and determines the location of each writing device in the image set. For example, according to the image sets acquired by the camera, the electronic device separately determines the specific location of the infrared pen A in its corresponding image set and determines the specific location of the infrared pen B in its corresponding image set. In a specific implementation process, to determine the specific location of the writing device, the receiver may specifically be an infrared camera, or may be an acquisition unit consisting of an ordinary camera and an infrared camera. Definitely, by those skilled in the art other receivers may also be selected as required, which will not be described in detail herein. In addition, in a specific implementation process, step S101 and step S102 are not limited to any particular order, and the two steps may be performed concurrently. The step S103 and the step S104 are not limited to any particular order, and the two steps may be performed concurrently.

In a specific implementation process, step S101 and step S102 have the same specific implementation principles, and the step S103 and the step S104 have the same specific implementation principles; therefore, in the following embodiments, the specific implementation processes of the step S101 and the step S103 will be described in detail, and the specific implementation processes of the step S102 and the step S104 will be omitted.

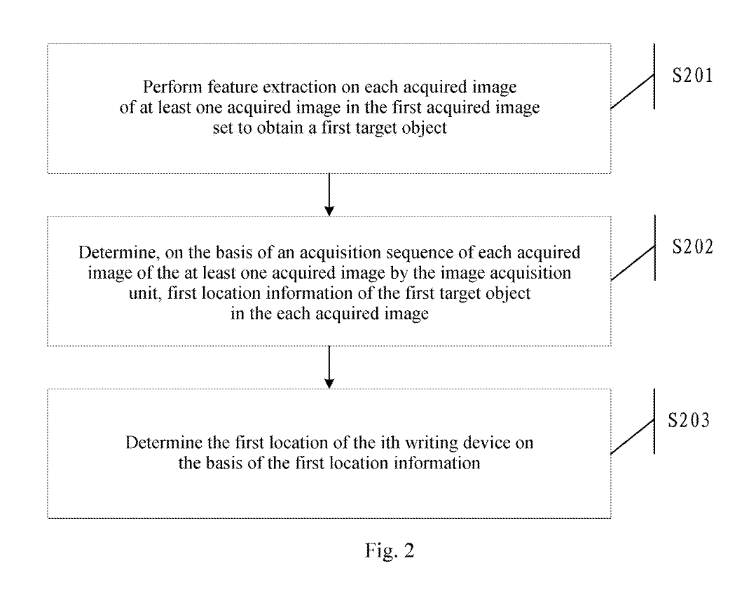

In this embodiment of the present application, referring to FIG. 2, the step S103 of determining a first location of the ith writing device according to the ith acquisition position and the first acquired image set specifically includes:

S201: performing feature extraction on each acquired image of at least one acquired image in the first acquired image set to obtain a first target object;

S202: determining, on the basis of an acquisition sequence of each acquired image of the at least one acquired image by the receiver, first location information of the first target object in the each acquired image; and

S203: determining the first location of the ith writing device on the basis of the first location information.

In a specific implementation process, the steps S201 to the step S203 are specifically implemented as the following process:

Firstly, feature extraction is performed on each acquired image of at least one acquired image in the first acquired image set to obtain a first target object. For example, the pen tip of the infrared pen is recognized. For another example, a flash point of an infrared light emitting diode disposed on the stylus pen is recognized when the infrared light emitting diode is flickering. Then, on the basis of an acquisition sequence of each acquired image of the at least one acquired image by the receiver, first location information of the first target object in the each acquired image is determined. For example, the camera performs image acquisition on the infrared pen C at acquisition positions “1, 4, 7, . . . 58” in the acquisition frequency, and then sequentially determines the locations of the pen tip of the infrared pen in the corresponding images at the acquired acquisition positions “1, 4, 7, . . . 58.” Then, the first location of the ith writing device is determined on the basis of the first location information. Still taking the infrared pen C as an example, the locations of the pen tip of the infrared pen C recognized in all the images are connected according to the acquisition sequence, so as to determine a trajectory of movement of the pen tip of the infrared pen C. On the basis of the same principle, a trajectory of movement of the pen tip of the infrared pen D and a trajectory of movement of the pen tip of the infrared pen E are determined, which will not be described in detail herein.

In this embodiment of the present application, the step S103 of controlling a receiver of an electronic device to perform image acquisition on an ith writing device in M writing devices at an ith acquisition position to obtain a first acquired image set is specifically: step A: controlling the receiver to perform, at the ith acquisition position, image acquisition on the ith writing device that flickers in a first preset manner in the M writing devices to obtain the first acquired image set. Still taking three infrared pens, that is, the infrared pen C, the infrared pen D and the infrared pen E as an example, when the camera is controlled to perform image acquisition on the infrared pen C at the acquisition positions “1, 4, 7, . . . 58” in the acquisition frequency, a light emitting diode in the infrared pen C is controlled to flicker at the corresponding acquisition positions “1, 4, 7, . . . 58.” In this case, light emitting diodes in the infrared pen D and the infrared pen E are both in a non-light-emitting state when the camera performs acquisition at the acquisition positions “1, 4, 7, . . . 58.” Therefore, multiple writing devices can all work normally.

In this embodiment of the present application, the step A has the following two implementation manners, but is not limited to the following two implementation manners. Those skilled in the art can set different implementation manners as required, which will not be described in detail herein.

First Implementation Manner

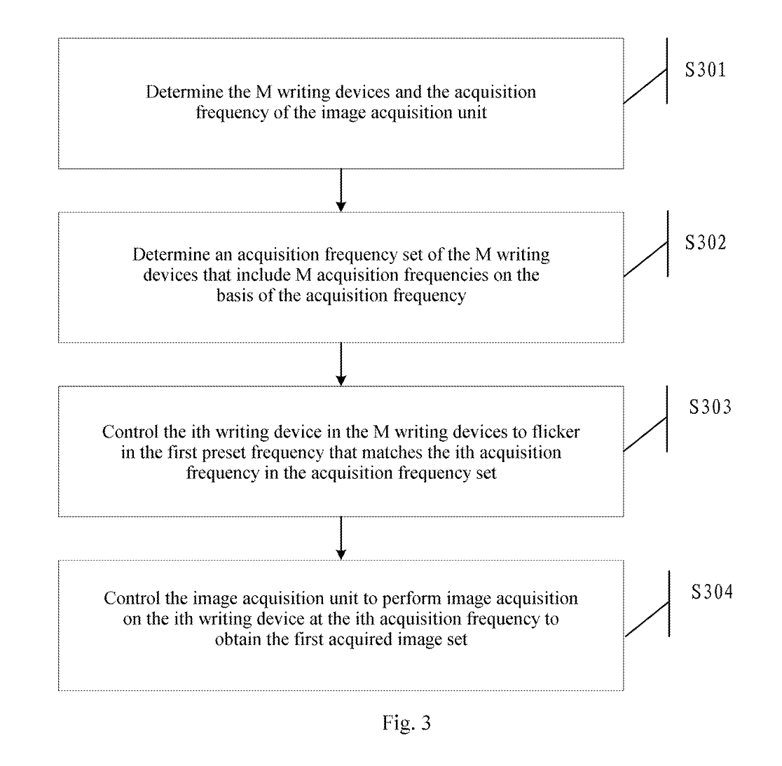

Referring to FIG. 3, the first implementation manner specifically includes: S301: determining the M writing devices and the acquisition position of the receiver;

S302: determining an acquisition position set of the M writing devices that include M acquisition frequencies on the basis of the acquisition position;

S303: controlling the ith writing device in the M writing devices to flicker in the first preset position that matches the ith acquisition position in the acquisition position set; and

S304: controlling the receiver to perform image acquisition on the ith writing device at the ith acquisition position to obtain the first acquired image set.

In a specific implementation process, the step S301 to the step S304 are specifically implemented as the following process:

Firstly, the M writing devices and the position of the receiver are determined. For example, the electronic device determines that there are currently three infrared pens, and that the current acquisition frequency of the camera is 60 frames per second. Then, an acquisition position set of the M writing devices that include M acquisition frequencies is determined on the basis of the acquisition position. For example, when there are currently three infrared pens, three acquisition position sets are determined. For example, the acquisition position of the infrared pen C is “1, 4, 7, . . . 58,” the acquisition position of the infrared pen D is “2, 5, 8, ... 59,” and the acquisition position of the infrared pen E is “3, 6, 9, . . . 60.” Then, the ith writing device in the M writing electronic devices is controlled to flicker in the first preset position that matches the ith acquisition position in the acquisition position set. Still taking the infrared pens C, D and E as examples, the light emitting diode in the infrared pen C is controlled to flicker at a frame rate that matches the acquisition positions “1, 4, 7, . . . 58.” That is to say, the infrared pen C is controlled to emit light at acquisition positions “1, 4, 7, . . . 58.” Cases of the infrared pen D and the infrared pen E will not be repeated in detail herein. Then, the receiver is controlled to perform image acquisition on the ith writing device at the ith acquisition position to obtain the first acquired image set. For example, the camera performs image acquisition on the infrared pen E at acquisition positions “3, 6, 9, . . . 60,” and then obtains an image set of the infrared pen E.

Second Implementation Manner

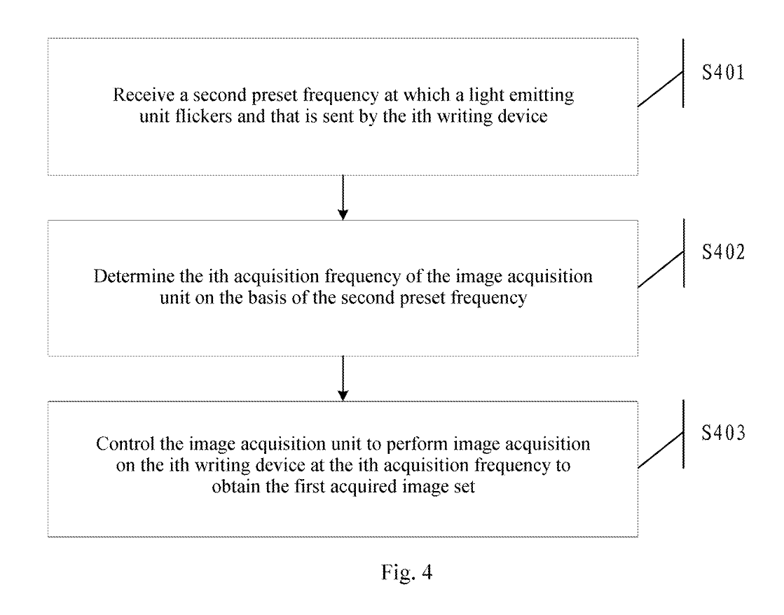

Referring to FIG. 4, the second implementation manner specifically includes:

S401: receiving a second preset position at which a light emitting unit flickers and that is sent by the ith writing device;

S402: determining the ith acquisition position of the receiver on the basis of the second preset position; and

S403: controlling the receiver to perform image acquisition on the ith writing device at the ith acquisition position to obtain the first acquired image set.

In a specific implementation process, step S401 to step S403 are specifically implemented as the following process: Firstly, the electronic device receives, from the ith writing device, a second preset position at which a light emitting unit flickers. For example, each stylus pen has multiple flickering modes, for example, flickering at “acquisition positions 1, 3, 5, . . . 59,” flickering at acquisition positions “1, 4, 7, . . . 58,” and flickering at “acquisition positions 1, 5, 8, . . . 117.” In use, a user can manually set the flickering mode of each stylus pen on the basis of the number of infrared pens that are currently being used. After the flickering mode of the stylus pens are set, each handwriting device sends the flickering position thereof to the electronic device. Then, on the basis of the second preset position, the ith acquisition position of the receiver is determined. That is to say, on the basis of the light emitting position of the handwriting device that is received by the electronic device, a matching acquisition position is determined. For example, when the infrared pen flickers at acquisition positions “1, 5, 8, . . . 117,” the acquisition position of the camera is acquisition positions “1, 5, 8, . . . 117.” Then, the receiver is controlled to perform image acquisition on the ith writing device at the ith acquisition position to obtain the first acquired image set.

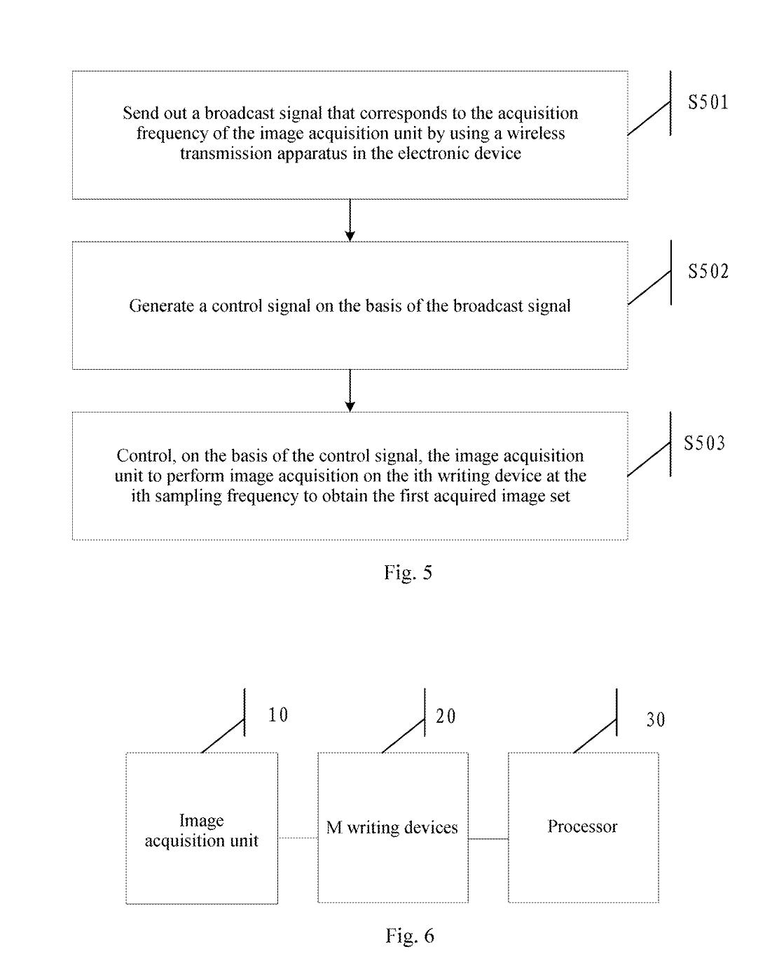

In this embodiment of the present application, referring to FIG. 5, the step S301 or the step S401 specifically includes:

S501: sending out a broadcast signal that corresponds to the position of the receiver by using a wireless transmission apparatus in the electronic device;

S502: generating a control signal on the basis of the broadcast signal; and

S503: controlling, on the basis of the control signal, the receiver to perform image acquisition on the ith writing device at the ith acquisition frequency to obtain the first acquired image set.

In a specific implementation process, step S501 to step S503 are specifically implemented as the following process:

Firstly, a wireless transmission apparatus in the electronic device sends out broadcast information corresponding to the acquisition position of the receiver. In a specific implementation process, the wireless transmission apparatus may specifically be Bluetooth, WIFI, NFC, or the like. In this case, each writing device is correspondingly provided with a wireless receiving apparatus. A communication connection between the electronic device and the writing device can further be established by means of broadcast transmitting/receiving modules in the electronic device and the writing device. For example, the electronic device is provided with a Bluetooth signal transmitter, and the writing device is provided with a Bluetooth signal receiver. The Bluetooth transmitter in the electronic device sends a broadcast signal corresponding to a position of 120 frames per second of the receiver to each writing device. Then, a control signal is generated on the basis of the broadcast information. The receiver is controlled on the basis of the control signal to perform image acquisition on the ith writing device at the ith acquisition frequency to obtain the first acquired image set. For example, when the electronic device broadcasts a broadcast signal corresponding to 60 frames per second to each writing device, it is equivalent to that the electronic device broadcasts the capturing time of each frame of the receiver. Then, a control signal corresponding is generated on the basis of the acquisition position of the receiver, and the receiver is controlled to perform image acquisition at an acquisition frequency that matches the flickering mode of the writing device.

In addition, in this embodiment of the present application, as the number of writing devices increases, a receiver with a higher acquisition frequency can be used so as to ensure that the receiver can accurately obtain the writing trajectory of the writing device. For example, when the current acquisition frequency is 60 frames per second, generally writing operations of two to five writing devices can be supported at the same time. If there are currently 10 writing devices, the receiver can obtain only six of images per second for each writing device. As a result, the accuracy of the obtained writing trajectory of the writing device is low. In this case, if a receiver with an acquisition frequency of 200 frames per second is used, the receiver can obtain 20 frames, instead of 6 frames, of images per second for each writing device, thereby ensuring the accuracy of the writing trajectory of the writing device. In a specific implementation process, those skilled in the art also can use a receiver with a particular acquisition frequency according to practical user requirements, which will not be described in detail herein.

In addition, in this embodiment of the present application, once the current number of writing devices changes, the electronic device still can adjust the number of acquisition positions acquired through image acquisition and adjust the flickering mode of each writing device on the basis of the current number of writing devices, thereby improving the writing accuracy of the writing device. For example, at the beginning, there are two stylus pens a and b, where the stylus pen a flickers at acquisition positions “1, 3, . . . 59,” and the receiver performs acquisition on the stylus pen a at the acquisition positions “1, 3, . . . 59”; the stylus pen b flickers at acquisition positions “2, 4, . . . 60” and the receiver performs acquisition on the stylus pen b at the acquisition positions “2, 4, . . . 60.” During the use of the stylus pens a and b, a stylus pen c is further used. In this case, on the basis of the current number of stylus pens, the electronic device adjusts the flickering modes of the stylus pens a, b and c, and at the same time adjusts the acquisition position of the receiver. The flickering modes and acquisition frequencies after adjustment are respectively at acquisition positions “1, 4, 7, . . . 58,” at acquisition positions “2, 5, 8, . . . 59,” and at acquisition positions “3, 6, 9, . . . 60.” Implementation processes corresponding to other changes in the number of writing devices during use will not be described in detail herein.

### Second Embodiment

Referring to FIG. 6, on the basis of the same inventive concept as the first embodiment of the present application, the embodiments of the present application also provide an electronic device, including: a receiver 10;
M writing devices 20; and
a processor 30, connected to the receiver 10, wherein the processor 30 is configured to:
control the receiver 10 to perform image acquisition on an ith writing device in M writing devices 20 at an ith acquisition position to obtain a first acquired image set, wherein i is an integer greater than or equal to 1 and smaller than or equal to M, the ith acquisition position is smaller than an image acquisition position of the receiver 10, and M is an integer greater than or equal to 2;
control the receiver 10 to perform image acquisition on a jth writing device in the M writing devices 20 at a jth acquisition position to obtain a second acquired image set, wherein j is an integer greater than or equal to 1 and smaller than or equal to M, and j is an integer different from i;
determine a first location of the ith writing device according to the ith acquisition position and the first acquired image set; and
determine a second location of the jth writing device according to the jth acquisition position and the second acquired image set.

In this embodiment of the present application, the processor 30 is configured to:
perform feature extraction on each acquired image of at least one acquired image in the first acquired image set to obtain a first target object;
determine, on the basis of an acquisition sequence of each acquired image of the at least one acquired image by the receiver 10, first location information of the first target object in the each acquired image; and
determine the first location of the ith writing device on the basis of the first location information.

In this embodiment of the present application, the processor 30 is configured to:
control the receiver 10 to perform, at the ith acquisition position, image acquisition on the ith writing device that flickers in a first preset manner in the M writing devices 20 to obtain the first acquired image set.

In this embodiment of the present application, the processor 30 is configured to:
determine the M writing devices 20 and the acquisition position of the receiver 10;
determine an acquisition position set of the M writing devices 20 that include M acquisition frequencies on the basis of the acquisition position;
control the ith writing device in the M writing devices 20 to flicker in the first preset position that matches the ith acquisition position in the acquisition position set; and control the receiver 10 to perform image acquisition on the ith writing device at the ith acquisition position to obtain the first acquired image set.

In this embodiment of the present application, the processor 30 is configured to:
receive a second preset position at which a light emitting unit flickers and that is sent by the ith writing device;
determine the ith acquisition position of the receiver 10 on the basis of the second preset position; and
control the receiver 10 to perform image acquisition on the ith writing device at the ith acquisition position to obtain the first acquired image set.

In this embodiment of the present application, the processor 30 is configured to:
send out a broadcast signal that corresponds to the position of the receiver 10 by using a wireless transmission apparatus in the electronic device;
generate a control signal on the basis of the broadcast signal; and
control, on the basis of the control signal, the receiver 10 to perform image acquisition on the ith writing device at the ith acquisition frequency to obtain the first acquired image set.

### Third Embodiment

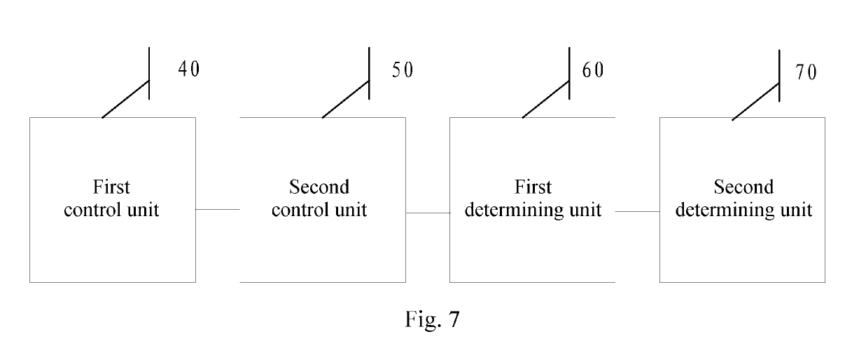

Referring to FIG. 7, on the basis of the same inventive concept as the first embodiment of the present application, the embodiments of the present application also provide an electronic device, including:
a first control unit 40, adapted to control a receiver of the electronic device to perform image acquisition on an ith writing device in M writing devices at an ith acquisition position to obtain a first acquired image set, wherein i is an integer greater than or equal to 1 and smaller than or equal to M, the ith acquisition position is smaller than an image acquisition position of the receiver, and M is an integer greater than or equal to 2;
a second control unit 50, adapted to control the receiver to perform image acquisition on a jth writing device in the M writing devices at a jth acquisition position to obtain a second acquired image set, wherein j is an integer greater than or equal to 1 and smaller than or equal to M, and j is an integer different from i;
a first determining unit 60, adapted to determine a first location of the ith writing device according to the ith acquisition position and the first acquired image set; and
a second determining unit 70, adapted to determine a second location of the jth writing device according to the jth acquisition position and the second acquired image set.

In this embodiment of the present application, the first determining unit 60 specifically includes:
a first obtaining module, adapted to perform feature extraction on each acquired image of at least one acquired image in the first acquired image set to obtain a first target object;
a first determining module, adapted to determine, on the basis of an acquisition sequence of each acquired image of the at least one acquired image by the receiver, first location information of the first target object in the each acquired image; and
a second determining module, adapted to determine the first location of the ith writing device on the basis of the first location information.

In this embodiment of the present application, the first control unit 40 is specifically adapted to:

control the receiver to perform, at the ith acquisition position, image acquisition on the ith writing device that flickers in a first preset manner in the M writing devices to obtain the first acquired image set.

In this embodiment of the present application, the first control unit 40 specifically includes:
a third determining module, adapted to determine the M writing devices and the acquisition position of the receiver;
a fourth determining module, adapted to determine an acquisition position set of the M writing devices that include M acquisition frequencies on the basis of the acquisition position;
a first control module, adapted to control the ith writing device in the M writing devices to flicker in the first preset position that matches the ith acquisition position in the acquisition position set; and
a second control module, adapted to control the receiver to perform image acquisition on the ith writing device at the ith acquisition position to obtain the first acquired image set.

In this embodiment of the present application, the first control unit 40 specifically includes:
a first receiving module, adapted to receive a second preset position at which a light emitting unit flickers and that is sent by the ith writing device;
a fifth determining module, adapted to determine the ith acquisition position of the receiver on the basis of the second preset position; and
a third control module, adapted to control the receiver to perform image acquisition on the ith writing device at the ith acquisition position to obtain the first acquired image set.

In this embodiment of the present application, the first control unit 40 specifically includes:
a first sending module, adapted to send out a broadcast signal that corresponds to the position of the receiver by using a wireless transmission apparatus in the electronic device;
a first generation module, adapted to generate a control signal on the basis of the broadcast signal; and
a fourth control module, adapted to control, on the basis of the control signal, the receiver to perform image acquisition on the ith writing device at the ith acquisition frequency to obtain the first acquired image set.

The following one or more technical effects can be achieved by using one or more technical solutions in the embodiments of the present application:

In the technical solutions of the present application, a receiver of an electronic device is controlled to perform image acquisition on an ith writing device in M writing devices at an ith acquisition position to obtain a first acquired image set, wherein i is an integer greater than or equal to 1 and smaller than or equal to M, the ith acquisition position is smaller than an image acquisition position of the receiver, and M is an integer greater than or equal to 2; the receiver is controlled to perform image acquisition on a jth writing device in the M writing devices at a jth acquisition position to obtain a second acquired image set, wherein j is an integer greater than or equal to 1 and smaller than or equal to M, and j is an integer different from i; a first location of the ith writing device is determined according to the ith acquisition position and the first acquired image set; and a second location of the jth writing device is determined according to the jth acquisition position and the second acquired image set. That is to say, the receiver of the electronic device is controlled to perform image acquisition on each writing device among multiple writing devices at different sampling frequencies, and further the location of each writing device can be determined, thereby achieving the technical effect that the electronic device can support handwriting operations of multiple stylus pens at the same time.

As will be appreciated by those skilled in the art, the embodiments of the present embodiments may be embodied as a method, a system, or a computer program product. Accordingly, the present embodiments may use the form of an entirely hardware embodiment, an entirely software embodiment or an embodiment combining software and hardware aspects. Furthermore, the present embodiments may use the form of a computer program product implemented on a computer-usable storage medium (including but not limited to magnetic disk memories, CD-ROMs, optical memories, etc.) containing computer-usable program code.

The present embodiments are described with reference to flow charts and/or block diagrams of the method, device (system) and computer program product in the embodiments of the present embodiments. It should be understood that computer program instructions can implement each process and/or block in the flow charts and/or block diagrams and a combination of processes and/or blocks in the flow charts and/or block diagrams. These computer program instructions may be provided to a general-purpose computer, a special-purpose computer, an embedded processor or a processor of another programmable data processing device to generate a machine, so that an apparatus configured to implement functions specified in one or more processes in the flow charts and/or one or more blocks in the block diagrams is generated by using instructions executed by the computer or the processor of another programmable data processing device.

These computer program instructions may also be stored in a computer readable memory that can guide a computer or another programmable data processing device to work in a specified manner, so that the instructions stored in the computer readable memory generate a product including an instruction apparatus, where the instruction apparatus implements functions specified in one or more processes in the flow charts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flow charts and/or one or more blocks in the block diagrams.

Specifically, the computer program instructions corresponding to the information processing method in the embodiments of the present application may be stored in a storage medium such as an optical disc, a hard disk or a USB flash drive. When being read or executed by an electronic device, the computer program instructions in the storage medium that correspond to the information processing method in the embodiments of the present application include the following steps:
controlling a receiver of an electronic device to perform image acquisition on an ith writing device in M writing devices at an ith acquisition position to obtain a first acquired image set, wherein i is an integer greater than or equal to 1 and smaller than or equal to M, the ith acquisition position is smaller than an image acquisition position of the receiver, and M is an integer greater than or equal to 2;
controlling the receiver to perform image acquisition on a jth writing device in the M writing devices at a jth acquisition position to obtain a second acquired image set, wherein j is an integer greater than or equal to 1 and smaller than or equal to M, and j is an integer different from i;
determining a first location of the ith writing device according to the ith acquisition position and the first acquired image set; and
determining a second location of the jth writing device according to the jth acquisition position and the second acquired image set.

Optionally, when being executed, the computer program instructions that are stored in the storage medium and that correspond to the step of determining a first location of the ith writing device according to the ith acquisition position and the first acquired image set specifically include:
performing feature extraction on each acquired image of at least one acquired image in the first acquired image set to obtain a first target object;
determining, on the basis of an acquisition sequence of each acquired image of the at least one acquired image by the receiver, first location information of the first target object in the each acquired image; and
determining the first location of the ith writing device on the basis of the first location information.

Optionally, when being executed, the computer program instructions that are stored in the storage medium and that correspond to the step of controlling a receiver of an electronic device to perform image acquisition on an ith writing device in M writing devices at an ith acquisition position to obtain a first acquired image set are specifically:
controlling the receiver to perform, at the ith acquisition position, image acquisition on the ith writing device that flickers in a first preset manner in the M writing devices to obtain the first acquired image set.

Optionally, when being executed, the computer program instructions that are stored in the storage medium and that correspond to the step of controlling the receiver to perform, at the ith acquisition position, image acquisition on the ith writing device that flickers in a first preset manner in the M writing devices to obtain the first acquired image set specifically include:
determining the M writing devices and the acquisition position of the receiver;
determining an acquisition position set of the M writing devices that include M acquisition frequencies on the basis of the acquisition position;
controlling the ith writing device in the M writing devices to flicker in the first preset position that matches the ith acquisition position in the acquisition position set; and
controlling the receiver to perform image acquisition on the ith writing device at the ith acquisition position to obtain the first acquired image set.

Optionally, when being executed, the computer program instructions that are stored in the storage medium and that correspond to the step of controlling the receiver to perform, at the ith acquisition position, image acquisition on the ith writing device that flickers in a first preset manner in the M writing devices to obtain the first acquired image set specifically include:
receiving a second preset position at which a light emitting unit flickers and that is sent by the ith writing device;
determining the ith acquisition position of the receiver on the basis of the second preset position; and
controlling the receiver to perform image acquisition on the ith writing device at the ith acquisition position to obtain the first acquired image set.

Optionally, when being executed, the computer program instructions that are stored in the storage medium and that correspond to the step of controlling the receiver to perform image acquisition on the ith writing device at the ith acquisition position to obtain the first acquired image set specifically include:
sending out a broadcast signal that corresponds to the position of the receiver by using a wireless transmission apparatus in the electronic device;
generating a control signal on the basis of the broadcast signal; and
controlling, on the basis of the control signal, the receiver to perform image acquisition on the ith writing device at the ith acquisition frequency to obtain the first acquired image set.

Although preferred embodiments of the present embodiments have been described, those skilled in the art can make additional variations or modifications to the embodiments after learning the basic inventive concept. Therefore, the appended claims should be construed as including the preferred embodiments and all variations and modifications that fall within the scope of the present embodiments.

It will be apparent to those skilled in the art that various modifications and variations can be made in the present embodiments without departing from the spirit or scope of the embodiments. Thus, it is intended that the present embodiments cover the modifications and variations of this embodiments provided they come within the scope of the appended claims and their equivalents.

What is claimed is

1. An electronic device, comprising:
an input device;
a plurality of writing devices that operatively input data via the input device and send signals, wherein each writing device sends signals from a position of the input device where the writing device is located, the signals comprising a unique characteristic; and
a receiver that operatively receives the signals of different characteristics from the plurality of writing devices, so as to determine the respective positions of the input device where the writing devices are located.

2. The electronic device of claim 1, further comprising a controller that determines an acquisition frequency and controls the receiver, where the acquisition frequency comprises M acquisition positions and each writing device sends signals during at least one acquisition position.

3. The electronic device of claim 2, wherein M is equal to a number of the plurality of writing devices and each ith writing device send signals during an ith acquisition position.

4. The electronic device of claim 2, wherein each writing device flickers at a second preset frequency and the controller determines the acquisition frequency from the second preset frequencies.

5. The electronic device of claim 2, wherein the controller controls the receiver with a control signal generated from a broadcast signal that corresponds to a position of the receiver.

6. The electronic device of claim 2, the controller controls the receiver to acquire the images at each acquisition position.

7. The electronic device of claim 1, wherein each image comprises a location of the corresponding writing device relative to the receiver within the acquisition position for the corresponding writing device.

8. A method of data input, comprising:
sending signals from a plurality of writing devices, wherein each writing device sends signals from a position of an input device where the writing device is located, the signals comprising a unique characteristic; and
receiving signals of different characteristics from the plurality of writing device, so as to determine the respective positions of the input device where the writing devices are located.

9. The method of claim 8, wherein an acquisition frequency comprises M acquisition positions and each writing device sends signals during at least one acquisition position.

10. The method of claim 9, wherein M is equal to a number of the plurality of writing devices and each ith writing device send signals during an ith acquisition position.

11. The method of claim 9, wherein each writing device flickers at a second preset frequency and the acquisition frequency is determined from the second preset frequencies.

12. The method of claim 8, wherein each image comprises a location of the corresponding writing device relative to a receiver within the acquisition position for the corresponding writing device.

13. The method of claim 8, the method further comprising controlling a receiver to acquire the images at each acquisition position.

14. The method of claim 13, wherein the receiver is controlled with a control signal generated from a broadcast signal that corresponds to a position of the receiver.

15. The method of claim 8, wherein each writing device flickers an infrared signal at the corresponding acquisition position.

16. The method of claim 8, wherein each writing device flickers an infrared signal in a first preset manner.

17. The method of clam 9, the method further comprising performing feature extraction on acquired image set to obtain a target object.

18. A system comprising:
an input device;
a plurality of writing devices that operatively input data via the input device and send signals, wherein each writing device sends signals from a position of the input device where the writing device is located, the signals comprising a unique characteristic;
a receiver that operatively receives the signals of different characteristics from the plurality of writing devices; and
a controller that operatively determines the respective positions of the input device where the writing devices are located

19. The system of claim 18, wherein an acquisition frequency comprises M acquisition positions and each writing device sends signals during at least one acquisition position.

20. The system of claim 18, wherein the receiver is a camera and the signals are infrared signals.
